(19) United States
(12) Patent Application Publication
(10) Pub. No.: US 2025/0300524 A1
(43) Pub. Date: Sep. 25, 2025

(54) ROTOR BALANCING DEVICE FOR LARGE MASS

(71) Applicant: ABB SCHWEIZ AG, Baden (CH)

(72) Inventors: Xiaofeng Xiu, Shanghai (CN); Jun Wang, Shanghai (CN); Xing Zhang, Shanghai (CN)

(21) Appl. No.: 19/230,847

(22) Filed: Jun. 6, 2025

Related U.S. Application Data
(63) Continuation of application No. PCT/CN2023/082801, filed on Mar. 21, 2023.

(51) Int. Cl. H02K 7/04; H02K 15/165

(52) U.S. Cl. CPC H02K 7/04; H02K 15/165

(57) ABSTRACT

A rotor balancing device includes a plurality of support members uniformly distributed on an axial end face of the rotor in a circumferential direction of the rotor; at least one balance weight block configured to compensate an unbalance of the rotor; and at least one fastener extending through the at least balance weight block in a radial direction of the rotor and configured to fix the at least one balance weight block to at least one of the plurality of support members in the radial direction of the rotor.

### FIELD

Embodiments of the present disclosure generally relate to an electrical rotation machine and in particular relate a to a rotor balancing device for a large mass imbalance.

### BACKGROUND

Electrical rotation machines, such as a motor or a generator, are widely used in an industrial filed. To improver performances of the electrical rotation machines, a rotor of the electrical rotation machine typical comprises winding coils. Due to complex and variant winding coil configuration of the rotor, an initial unbalance of the rotor is very large, for example, up to 5 kg or higher. In many applications, an initial unbalance may reach up to 2-5 kg per balancing end plane (i.e., one end plane of a rotor core). In order to balance this large mass imbalance, a balance block is fixed to the end plane of a rotor core to compensate the imbalance.

Since the initial unbalance is so large that the balance block is subject to a huge centrifugal force during operation of the electrical ration machine. There is a high risk that the balance block would fall off under action of the huge centrifugal force, which is dangerous. A fixing means for fixing the balance block to the end plane of the rotor core is critical to ensure the fixing strength and other requirements (such as space limitations). Conventional fixing means is not suable for balancing large mass. Thus, there is a need to provide a rotor balancing device for large mass.

### SUMMARY

Example embodiments of the present disclosure provide a rotor balancing device, an electrical rotation machine and a method of balancing a rotor which can achieve large mass balance compensation for a rotor of an electrical rotation machine.

In a first aspect of the present disclosure, it is provided a rotor balancing device. The rotor balancing device comprise: a plurality of support members uniformly distributed on an axial end face of the rotor in a circumferential direction of the rotor; at least one balance weight block configured to compensate an unbalance of the rotor; and at least one fastener extending through the at least balance weight block in a radial direction of the rotor and configured to fix the at least one balance weight block to at least one of the plurality of support members in the radial direction of the rotor. With this arrangement, the balance weight block is installed on the support members located at axial end surface of the rotor in the radial direction of the rotor. The extending direction of the fastener thus is in the radial direction of the rotor which is the same as the direction of the centrifugal force during rotation of the rotor. Thus, the huge centrifugal force caused by the large mass is transmitted from the fastener to the support member. Accordingly, the rotor imbalance can be safely and easily compensated.

In some embodiments, the plurality of support members may be arranged outside an axial air duct of the rotor. With this arraignment, the balance weight block is free of risk of blocking the axial air duct of the rotor.

In some embodiments, the balance weight block may comprise a plurality of sheet-like laminated steel plates. With this arrangement, the balance weights to be used can be easily adjusted.

In some embodiments, the support member may comprise a contact surface adapted to contact the balance weight block in the radial direction of the rotor via a surface contact. With this arrangement, the contact area between the balance weight block and the support member is enlarged to improve strength.

In some embodiments, the support member may be provided on an end platen for a rotor core and/or on a support ring for the supporting a rotor coil at an inner radial side. With this arrangement, the support member can be easily formed on the axial end surface of the rotor.

In some embodiments, the support member is a support bar connecting the end platen for the rotor core to a support ring for the supporting a rotor coil at an inner radial side. With this arrangement, the support bar may be sued as a support member of the rotor balancing device.

In some embodiments, the fastener may comprise a screw. With this arrangement, the balance weight block can be fixed to the support member by the screw.

In some embodiments, the balance weight block may be fixed to two adjacent support members of the plurality of support members via two fasteners. With this arrangement, the balance weight block can be fixed with increased strength. Also, the balance weight block may be prevented from rotation.

In some embodiments, the balance weight block may comprise a plurality of laminated steel plates, each steel plate comprising a first portion and a second portion connected to the first portion at an obtuse angle to form a V-shaped steel plate. With this arrangement, the balance weight block can fixed to two adjacent support member with simplified structure.

In some embodiments, at least one of the first portion and the second portion may comprise a circular through hole, and the fastener passes through the circular through hole to radially fix the balance weight block to the respective support member.

In some embodiments, for each of the plurality of laminated steel plates, a distance from a center of the circular through hole to a vertex of a V-shape may be different from one steel plate to another, and the plurality of laminated steel plates are arranged in a predetermined order to form the balance weight block.

In a second aspect of the present disclosure, it is provided an electrical rotation machine. The electrical rotation machine comprise: a rotor; and the rotor balancing device according to any one of the first aspect being mounted to the rotor for balancing an unbalance of the rotor.

In some embodiments, the electric machine may comprise a motor or a generator.

In a third aspect of the present disclosure, it is provided a method of balancing a rotor. The method of balancing a rotor comprise: providing at least one balance weight block for compensating an imbalance of the rotor; and fixing, via at least one fastener, the at least one balance weight block to at least one of a plurality of support members in the radial direction of the rotor, the plurality of support members being uniformly distributed on an axial end face of the rotor in a circumferential direction of the rotor.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic overall perspective view of a rotor of an electrical rotation machine according to one example embodiment of the present disclosure;

FIG. 2 is a perspective view of an axial end face of the rotor according to one example embodiment of the present disclosure;

FIG. 3 is a closed-up view of a portion of FIG. 2;

FIG. 4 is a plane view of an axial end face of the rotor according to one example embodiment of the present disclosure;

FIG. 5 is a schematic view of a balance weight block according to one example embodiment of the present disclosure;

FIG. 6 is a schematic view of one laminated steel plate of a balance weight block according to another example embodiment of the present disclosure;

FIG. 7 is a plane view of an axial end face of the rotor according to yet another example embodiment of the present disclosure; and

FIG. 8 is a flow chart of a method of balancing a rotor according to one example embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

As mentioned in background part of the present disclosure, due to complex and variant winding coil of the rotor of electrical rotation machine (such as a motor or a generator), an initial unbalance of rotor is very large. There are several conventional methods to fix balance pieces to the axial end surface of the rotor core. One conventional method is to fix the balance pieces to the axial end surface of the rotor core by bolts extending along an axial direction of the rotor. This method cannot be used to balance pieces of large mass. That is because the bolt is subject to very huge centrifugal force. There is also a risk that ventilation holes of the rotor core for cooling may be blocked by the balance pieces in view of the space restrictions. Another conventional method is to weld the balance pieces to the axial end surface of the rotor core. But this method is also subject to a plural of drawbacks. Welding such a heavy balance pieces at the end of rotor core is impractical and time-consuming. This method also faces a risk that ventilation holes of the rotor core for cooling may be blocked by the balance pieces in view of the space restrictions. According to the present disclosure, a novel device for fixing the balance pieces to the axial end surface of the rotor core is provided, which can solve the one or more of the above technical problems.

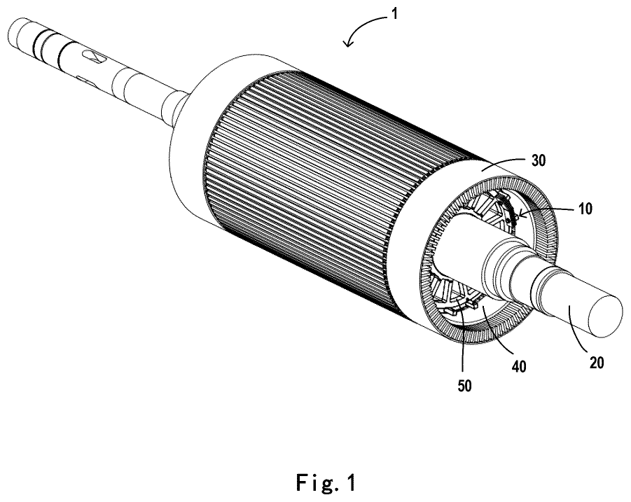

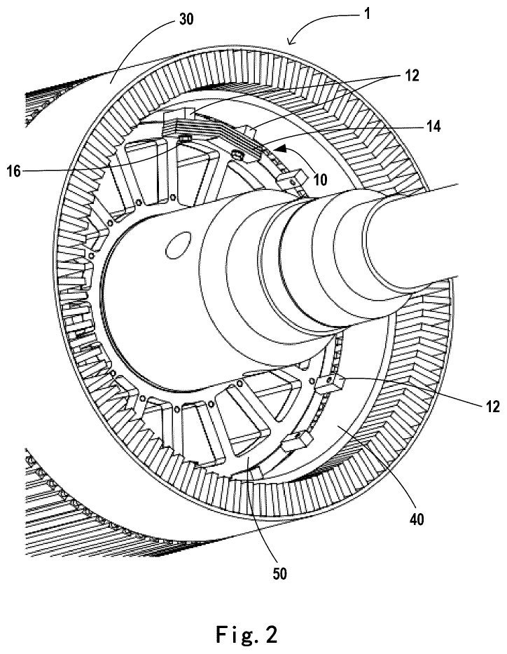

FIG. 1 is a schematic overall perspective view of a rotor 1 of an electrical rotation machine according to one example embodiment of the present disclosure and FIG. 2 is a perspective view of an axial end face of the rotor according to one example embodiment of the present disclosure. The electrical rotation machine may be a motor or a generator. In the shown example, for sake of clarity, only a rotor is shown and other parts related to the electrical rotation machine are omitted.

As shown in FIGS. 1 and 2, the rotor 1 includes a shaft 20 provided at a center, a rotor core including a plural of laminated silicon steel plates arranged around the shaft 20, and winding coils provided at a radial outer side of the rotor. In the shown example, an end platen 50 for the rotor core is shown and is used for pressing and fixing the plural of laminated silicon steel plates together. The end platen 50 and the rotor core may include axial air ducts 54 which may be used for cooling the rotor during operation of the electrical rotation machine. A radial outer hoop 30 is provided at one axial end of the rotor to support winding coils at the radial outer side. A support ring 40 is provided at one axial end of the rotor to support winding coils at the radial inner side. It is to be understood that the above shown structure of the rotor is merely illustrative rather than limited.

As shown in FIGS. 1 and 2, a rotor balancing device 10 is also shown. The rotor balancing device 10 is used to correct imbalance of the rotor. This can be done during balance test of the rotor, for example, after components are assembled. During the balance test of the rotor, angle positions for weight compensation for each of two axial end surfaces of the rotor are determined and the balance weight are fixed to the determined angle positions to realize rotor balance.

FIGS. 3-5 show structural details of the rotor balancing device 10 according to one example embodiment of the present disclosure. As shown in FIGS. 3-5, the rotor balancing device 10 includes a plurality of support members 12 and one or more balance weight blocks 14. The support members 12 are used to radially support the balance weight block 14. There are a number of support members 12 which are circumferentially distributed on an axial end face of the rotor and can be formed in advance. In some embodiments, the support members 12 are uniformly provided on an axial end face of the rotor. When the angle positions for weight compensation are determined during balance test, the support members 12 corresponding to the determined angle positions can be selected and the balance weight blocks 14 thus can be fixed to the selected support members 12. In the shown example, the number of the support members 12 is 16. It is to be understood that this is merely illustrative, and the number of the support members 12 may be more or less.

In some embodiments, also referring to FIG. 2, at least portion of the support member 12 extends in the axial direction of the rotor such that the support member 12 can withstand a huge centrifugal force caused by the balance weight blocks 14. In some embodiments, the support members 12 are provided on the end platen 50 and extend in the axial direction of the rotor. In this case, an axial extension portion of the support members 12 can be used to radially support the balance weight blocks 14. In some embodiments, the support members 12 are provided on the support ring 40 and extend in the radial direction of the rotor. In this case, a radial extension portion of the support members 12 can be used to radially support the balance weight blocks 14. In some embodiments, the end platen 50 for the rotor core may be connected the support ring 40 by a plural of support bars to improve strength. In this case, the support bar may be used as the support members 40. It is to be understood that this is merely illustrative and the support members 12 may be provided any other proper components at the axial end surface of the rotor as long as the support members 12 can provide radial support for the balance weight block 14.

In some embodiments, the support member 12 is configured to contact the balance weight block 14 in the radial direction of the rotor via a surface contact. With the surface contact between the balance weight block 14 and a support member 12, a large contact area can be ensured.

In some embodiments, the balance weight block 14 comprises a plurality of sheet-like laminated metal plates, e.g., steel plate. A through hole may be provided on the balance weight block 14. The fastener 16 extends through the through hole of the balance weight block 14 in a radial direction of the rotor and fixes the balance weight block 14 to the support member 12 in the radial direction of the rotor. The fastener 16 may include screw connection, such as a screw (e.g., a bolt). A threaded hole may be provided in the support member 12. The screw is configured to engage the threaded hole and the balance weight block 14 is thus sandwiched between the support member 12 and the screw.

In the present disclosure, the balance weight block 14 is installed on axial end surface of the rotor in the radial direction of the rotor. That means, the extending direction of the fastener is in the radial direction of the rotor which is the same as the direction of the centrifugal force during rotation of the rotor. Thus, the fastener does not withstand the huge centrifugal force during rotation of the rotor. Rather, the huge centrifugal force is transmitted from the fastener to the support member, and in turn to the end platen 50 and/or the support ring 40, which can withstand the huge centrifugal force.

In some embodiments, the rotor balancing device 10 is located outside an axial air duct 54 of the rotor. As shown in FIG. 3, the plurality of support members 12 is arranged outside an axial air duct 54 of the rotor where there is sufficient room for receiving balance weight block 14. In this way, the risk of blocking the axial air duct 54 is reduced.

In some embodiments, as shown in FIGS. 3-5, the balance weight block 14 may be fixed to two adjacent support members of the plurality of support members 12 via two fasteners. Since two circumferential fixing points are used to fix the balance weight block 14, the balance weight block 14 can be prevented from rotation.

As shown in FIGS. 3-5, the balance weight block 14 may be formed by a plurality of laminated metal plates 141, 142, 143, 144 of the same weight. In the shown example, four steel plates are shown. It is to be understood that the number of the steel plates are merely illustrative. Each metal plate may be V-shaped. As shown, each steel plate may include a first portion and a second portion connected to the first portion at an obtuse angle. The first portion and the second portion thus form a V-shape. It is to be understood that the steel plate may be of any proper shapes as long as the steel plate can be reliably and robustly fixed.

In order to fix the balance weight block 14, through holes may be provided in each of the metal plates 141, 142, 143, 144 for connection. In some embodiments, the through holes may be circular. This is advantageous since a gap between a fastener stem of the fastener and a circumferential inner wall of the through hole can be minimized. This may facilitate reduction of vibration of the balance weight block 14.

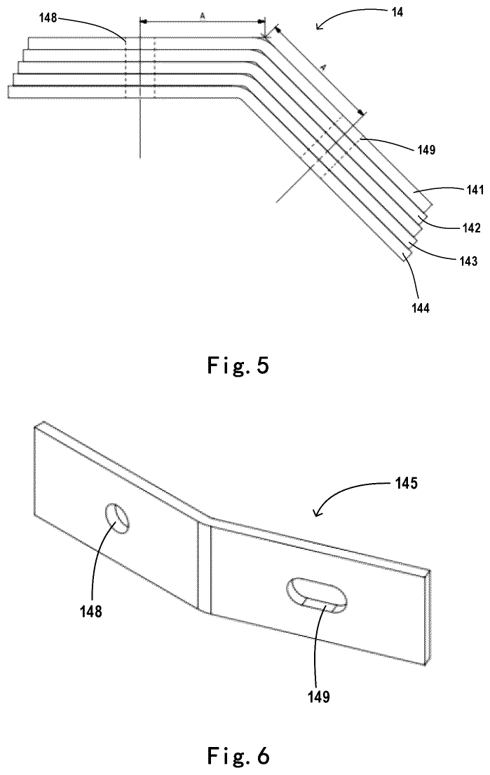

In some embodiments, as shown in FIG. 5, both through holes of the metal plates 141, 142, 143, 144 are circular. The metal plates 141, 142, 143, 144 are laminated in the radial direction of the rotor. When the through holes of the metal plates 141, 142, 143, 144 are circular, the through hole have to be aligned with respect each other such that the fastener can extend through the metal plates 141, 142, 143, 144. In some embodiments, for each of the plurality of laminated steel plates, a distance “A” from a center of the circular through hole 148 to a vertex of a V-shape is different from one steel plate to another, and the plurality of laminated steel plates are arranged in a predetermined order to form the balance weight block 14.

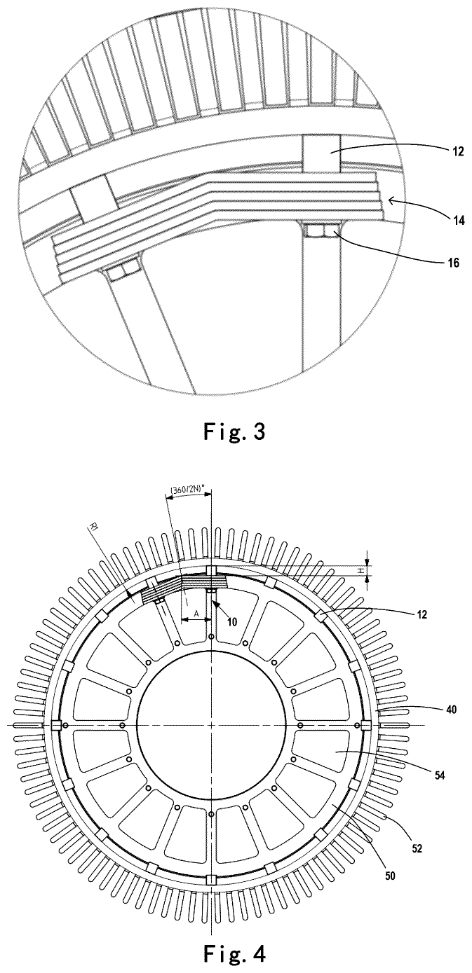

The dimension “A” may be determined by the radial position of the support member 12. As shown in FIG. 4, when the support member 12 is fixed to the support ring 50, the dimension “A” may be determined by following expression.

$$A = ( R 1 - H ) * tan ( 360 / 2 N )$$

where “A” refers to a distance from a center of the circular through hole 148 to a vertex of the top V-shape steel plate, “R1” refers to an inner radius of the support ring 50, “H” refers to a height of the support member 12, “N” refers to the number of the support members 12. In some embodiments, once the dimension “A” the top V-shape steel plate is determined, a position for forming the circular through hole 148 can be known, and all circular through holes 148 in the laminated steel plates can be simultaneously formed, for example, by one punching process. This avoids the need to form the circular through hole in each steel plate one by one.

Each V-shape steel plate can be marked with a number from 1 to “n” in order from top to bottom and thus can be combined to form the balance weight block 14. Mounting holes can be machined after packing. According to the measured actual unbalance and phase dynamic balancing machine, V-shape steel plates are installed in sequence from No. 1 to No. n.

In some embodiments, as shown in FIG. 6, one through hole 148 of the metal plate is circular while the other through hole 149 of the metal plate is non-circular, for example, a waist shape hole. This is advantageous since the waist shape hole allows an insertion of the fastener to be adjusted.

FIG. 7 is a plane view of an axial end face of the rotor according to yet another example embodiment of the present disclosure. The example embodiment in FIG. 7 is substantially the same as the example embodiment shown in FIG. 4. The difference is that the balance weight block 14 in FIG. 7 is formed by a plurality of planer metal plates. As shown in FIG. 7, a plurality of planer metal plates are fixed to the support member 12 via the fastener 12. This is in particular suitable for low mass imbalance.

In the shown example of FIG. 7, the balance weight block 14 is formed by a plurality of planer metal plates. It is to be understood that this is merely illustrative and the metal plate may be formed as any other proper shapes. In some embodiments, the metal plate may be shaped to engage with the support member 12 such that rotation of the metal plate can be prevented during rotation of the rotor.

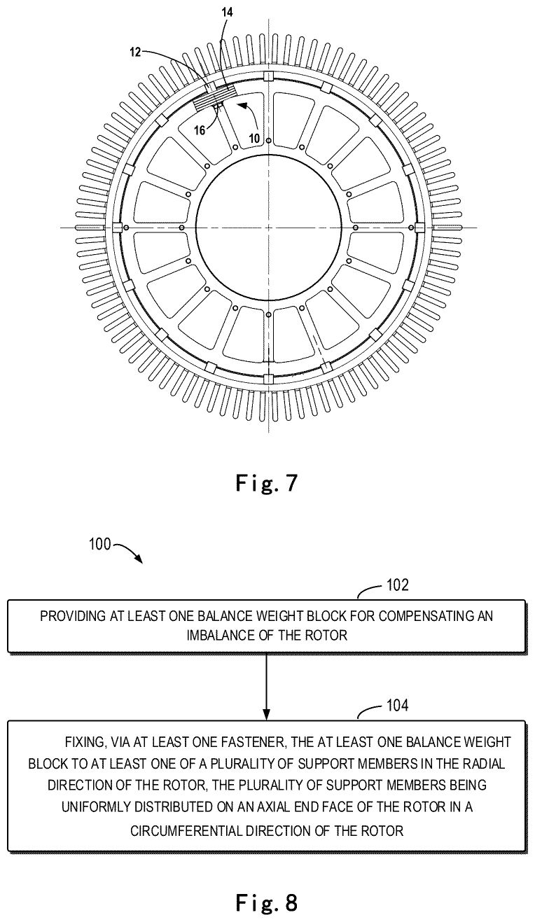

FIG. 8 is a flow chart of a method 100 of balancing a rotor according to one example embodiment of the present disclosure. At block 102, at least one balance weight block for compensating an imbalance of the rotor is provided. At block 104, the at least one balance weight block is fixed to at least one of a plurality of support members in the radial direction of the rotor via at least one fastener. The plurality of support members are uniformly distributed on an axial end face of the rotor in a circumferential direction of the rotor and are formed in advance.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. A rotor balancing device comprising:
a plurality of support members uniformly distributed on an axial end face of the rotor in a circumferential direction of the rotor;
at least one balance weight block configured to compensate an unbalance of the rotor; and
at least one fastener extending through the at least balance weight block in a radial direction of the rotor and configured to fix the at least one balance weight block to at least one of the plurality of support members in the radial direction of the rotor.

2. The rotor balancing device according to claim 1, wherein the plurality of support members are arranged outside an axial air duct of the rotor.

3. The rotor balancing device according to claim 1, wherein the balance weight block comprises a plurality of sheet-like laminated steel plates.

4. The rotor balancing device according to claim 1, wherein the support member comprises a contact surface adapted to contact the balance weight block in the radial direction of the rotor via a surface contact.

5. The rotor balancing device according to claim 1, wherein the support member is provided on an end platen for a rotor core and/or on a support ring for the supporting a rotor coil at an inner radial side.

6. The rotor balancing device according to claim 1, wherein the support member is a support bar connecting the end platen for the rotor core to a support ring for the supporting a rotor coil at an inner radial side.

7. The rotor balancing device according to claim 1, wherein the fastener comprises a screw.

8. The rotor balancing device according to claim 1, wherein the balance weight block is fixed to two adjacent support members of the plurality of support members via two fasteners.

9. The rotor balancing device according to claim 8, wherein the balance weight block comprises a plurality of laminated steel plates, each steel plate comprising a first portion and a second portion connected to the first portion at an obtuse angle to form a V-shaped steel plate.

10. The rotor balancing device according to claim 9, wherein at least one of the first portion and the second portion comprises a circular through hole, and the fastener passes through the circular through hole to radially fix the balance weight block to the respective support member.

11. The rotor balancing device according to claim 10, wherein for each of the plurality of laminated steel plates, a distance from a center of the circular through hole to a vertex of a V-shape is different from one steel plate to another, and the plurality of laminated steel plates are arranged in a predetermined order to form the balance weight block.

12. An electrical rotation machine comprising:
a rotor; and
the rotor balancing device according to claim 1 being mounted to the rotor for balancing an unbalance of the rotor.

13. The electrical rotation machine according to claim 12, comprising a motor or a generator.

14. A method of balancing a rotor comprising:
providing at least one balance weight block for compensating an imbalance of the rotor; and
fixing, via at least one fastener, the at least one balance weight block to at least one of a plurality of support members in the radial direction of the rotor, the plurality of support members being uniformly distributed on an axial end face of the rotor in a circumferential direction of the rotor.

15. The rotor balancing device according to claim 2, wherein the balance weight block is fixed to two adjacent support members of the plurality of support members via two fasteners.

16. The rotor balancing device according to claim 5, wherein the balance weight block is fixed to two adjacent support members of the plurality of support members via two fasteners.

17. The rotor balancing device according to claim 7, wherein the balance weight block is fixed to two adjacent support members of the plurality of support members via two fasteners.
